(19) United States
(12) Patent Application Publication
(10) Pub. No.: US 2011/0025055 A1
(43) Pub. Date: Feb. 3, 2011

(54) Domestic combined heat and power generation system

(76) Inventors: Stephen Michael Hasko, Huntingdon (GB); Heather Allderidge, Derby (GB); James Robert Lowrie, Liverpool (GB)

Correspondence Address: Ballard Spahr LLP, SUITE 1000, 999 PEACHTREE STREET, ATLANTA, GA, 30309-3915, US

(21) Appl. No.: 12/308,626

(22) PCT Filed: Jun. 29, 2007
(86) PCT No.: PCT/GB2007/002436

§ 371 Date: Oct. 11, 2010

(30) Foreign Application Priority Data
Jun. 30, 2006 (GB) 0613142.9

(51) Int. Cl. H02K 7/18; F02G 1/043

(52) U.S. Cl. 290/2

(57) ABSTRACT

A domestic combined heat and power generation system comprising a pair of Stirling engines mounted so that the vibrations of one substantially counteract the vibrations of the other. At least one engine burner heats the heads of the engines. An auxiliary burner provides additional heat. Gas and air are supplied to the engine burner and auxiliary burner controlled by a controller. A heat exchanger recovers heat from the exhaust gases from the engine burner and auxiliary burner and provide a heat output. An electrical output is provided from an alternator of each engine. The engines having a combined electrical power output of less than 2.5 kW.

The present invention relates to a domestic combined heat and power generation system.

In particular, the invention relates to a domestic combined heat and power (DCHP) generation system which uses Stirling engine technology. Examples of such systems are disclosed in WO 03/042566, WO 04/101982 and WO 04/85893.

When the displacer and power pistons in the Stirling engine reciprocate, they cause an overall vibration of the Stirling engine in the direction of reciprocation. In order to counteract this, a large absorber mass is resiliently attached to the engine and is set up to vibrate in anti-phase to the vibrations of the Stirling engine (as shown, in particular, in WO 03/042566). This has the effect of substantially cancelling out the engine vibration. However, it also has the effect of significantly increasing the overall mass of the system.

Further, the absorber mass is attached to the engine by at least one spring with the mass and spring(s) being tuned to provide maximum vibration attenuation tuned to the most common operating frequency. In practice, this is likely to vary somewhat during normal operation. Also, during times of transient operation such as start-up, the engine will be operating somewhat away from the frequency to which the vibration absorption is tuned. Thus, energy will be lost, and noise/vibration levels will rise, during the time when the engine is operating away from the tuned frequency.

According to the present invention, there is provided a domestic combined heat and power generation system comprising a pair of Stirling engines each having a head and an alternator, the two engines being mounted so that the vibrations of one substantially counteract the vibrations of the other;

at least one engine burner to heat the heads of the engines;

an auxiliary burner to provide additional heat;

a gas supply to the engine burner and auxiliary burner;

an air supply to the engine burner and auxiliary burner;

a controller to control the supply of gas and air to the engine burner and auxiliary burner;

a heat exchanger assembly to recover heat from the exhaust gases from the engine burner and auxiliary burner and provide a heat output from the system; and

an electrical connection to the alternators to provide an electrical outlet from the system, the engines having a combined electrical power output of less than 2.5 kW.

The invention therefore provides, for the first time, a domestic combined heat and power generation system with a pair of Stirling engines.

The benefit of such a system is that, as the two engines are arranged to counteract each other's vibrations, the large absorber mass is no longer required. For a given power output, the mass of the two engines is less than that of a single engine with an absorber mass.

Also, as the Stirling engines are dynamic systems, these can be operated in tandem to provide dynamic absorption vibration, matching one another across a range of operating frequencies. The above problem with the absorber mass being tuned for a specific frequency can therefore by avoided.

The idea of using a balanced pair of Stirling engines has been proposed in the past for specific applications. For example, the idea has been disclosed by NASA to provide a power source in spacecraft designed for deep space travel using a radioisotope as the power source. See, for example, “NASA GRC Stirling Technology Development Overview, Lanny G. Thieme and Jeffrey G. Schreiber (NASA/TM-2003-212454”) and “Overview of NASA GRC Stirling Technology Development”, Jeffrey G. Schreiber and Lanny G. Thieme (NASA/TM-2004-2121969).

Also, the idea has also been used by Sunpower, Inc. For example, in a document entitled Development of a High Frequency Engine-Powered 3 Kw(e) Generator Set” (Proceedings of the 24 the Intersociety Energy Conversion Engineering Conference. Volume 5. New York: Institute of Electrical and Electronics Engineers 1989). This refers to the use of the balanced of pair Stirling engines in an electrical generator suitable for use by the US Army. The pair uses a gas-fired sodium heat pipe and has an electrical outlet of 3 kW(e).

A second Sunpower document “A 5 kW Electric Free-Piston Stirling Engine”, Neil W. Lane and William T. Beale presented at the 7th International Conference on Stirling Cycle Machines, Tokyo, Japan Nov. 5-8 1995 discloses a 5 kW system. This has been specifically designed to power portable saw mills. It is stated as also being suitable for small scale natural gas-fired co-generation. However, no information is provided as to how such a system would be implemented. Also, an engine of this power output is unsuitable for most domestic environments.

There are a number of ways in which the two engines could be mounted. They can share a common housing. In this case, part of the gas space within the housing is common to both engines. They may be two engines each having their own independent internal gas space which are mounted directly to one another, or they may be two independent engines which are mounted on a common support.

Each engine has a hot end which is heated by the heat source. The engines may be mounted such that the heads are furthest from each other. However, preferably, the engines are mounted so that the heads of the two engines are adjacent to one another. This allows the heads to share at least some elements of a common burner assembly.

If the engines are mounted in a head-to-head configuration, the burner assembly preferably has at least some components with a segmented configuration arranged to be assembled around the engine heads. This allows the burner assembly to be installed after the engine is in place, and also allows the burner assembly to be removed for routine maintenance.

The two engine heads may share a common burner element. This allows the use of a common fuel supply for the heating of both engine heads. In this case, each engine is preferably associated with its own exhaust gas outlet, and each exhaust gas outlet preferably has a control valve. This allows some independent control and balancing of the temperature characteristics of each engine head.

Alternatively, each engine may be associated with its own burner assembly. This allows greater control of the individual engine characteristics which can be achieved by controlling the flow rate of combustible gas to the burners, and also provides the possibility of a single exhaust outlet for the two burners thereby simplifying the design.

The heat exchanger assembly may comprise separate heat exchangers for the two burners. However, preferably, a single heat exchanger receives gases from both the engine burner and auxiliary burner.

Examples of power generation systems in accordance with the present invention will now be described with reference to the accompanying drawings, in which:—

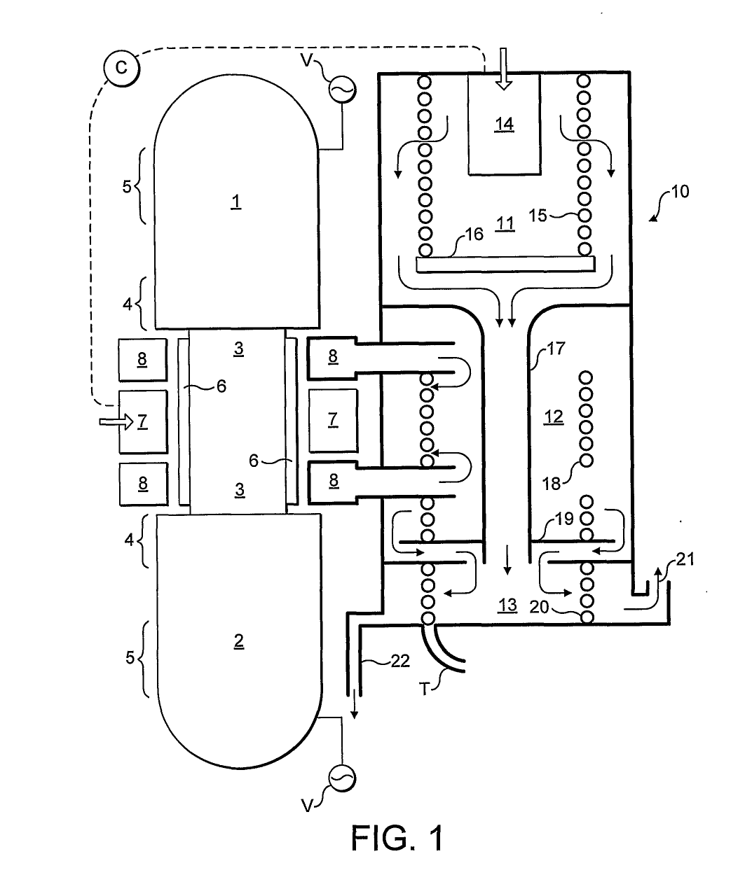

FIG. 1 is a schematic view of a first system;

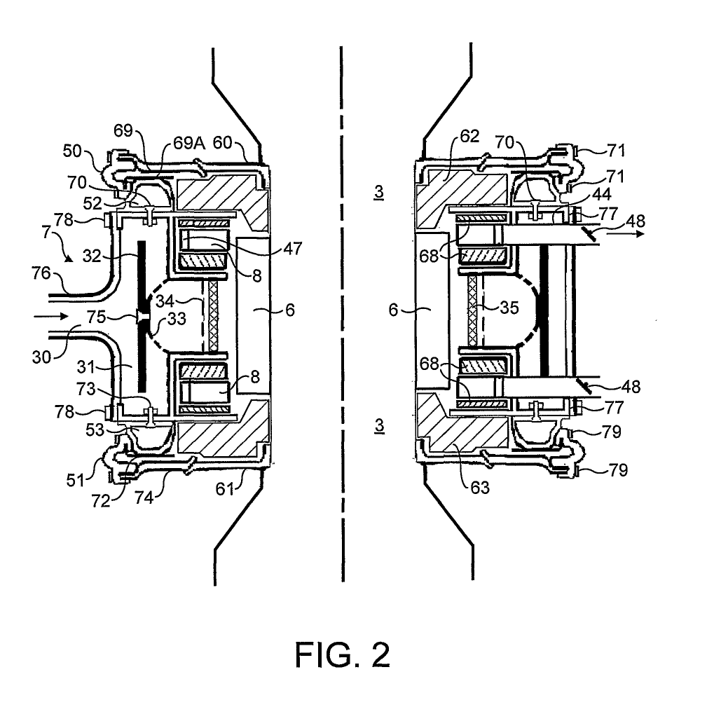

FIG. 2 is a more detailed view of the burner and exhaust assembly of the first system;

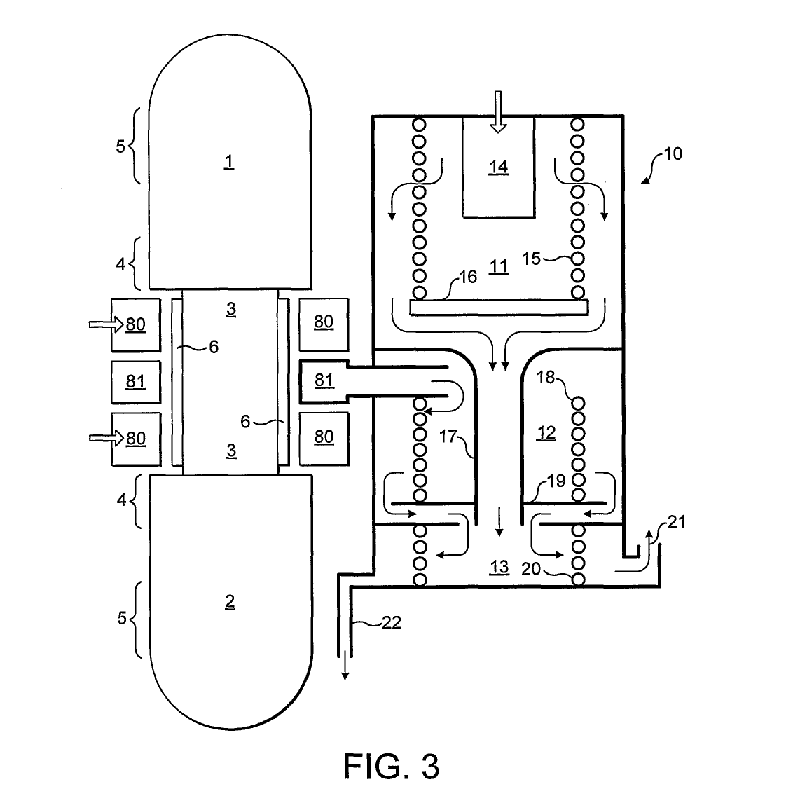

FIG. 3 is a schematic view similar to FIG. 1 of a second system;

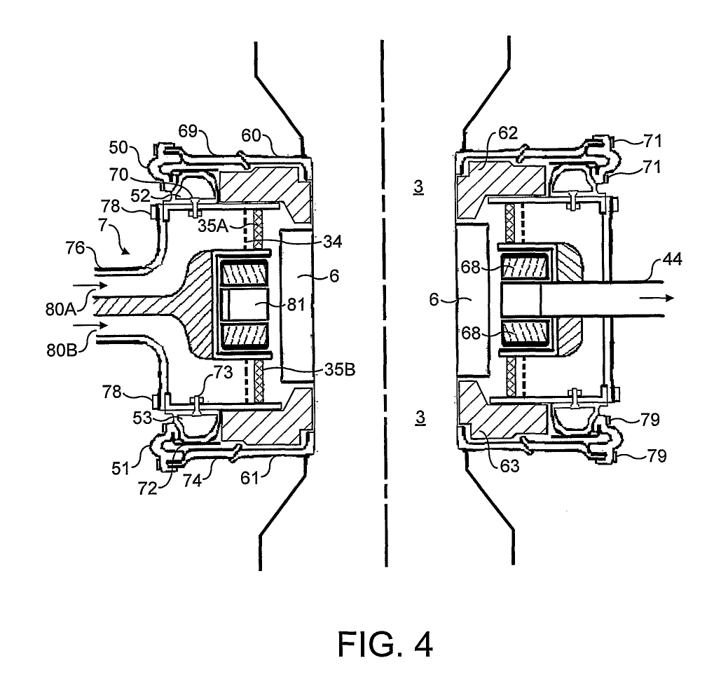

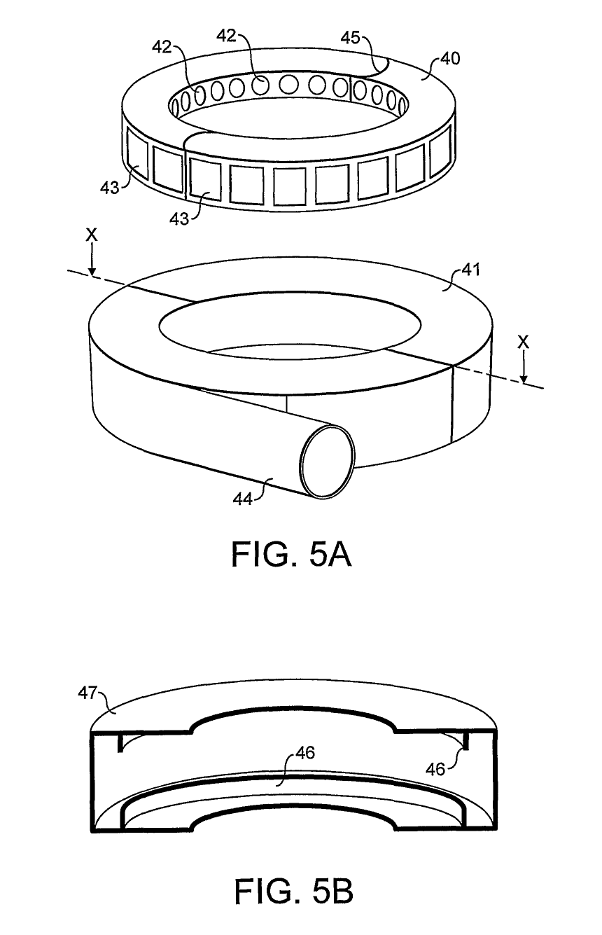

FIG. 4 is a more detailed view of the burner and exhaust assembly of the second system; FIG. 5A is an exploded view of the flue gas collector; and

FIG. 5B is a section through line X-X in FIG. 5a showing the collector manifold.

FIG. 1 shows a first linear free piston Stirling engine 1 and a second linear free piston Stirling engine 2. Each engine has a head 3, a cooled region 4 cooled by a coolant circuit (not shown) and an alternator region 5 at which electrical power is generated as one or more electrical outputs V. All of these aspects of a Stirling engine are very well-known in the art.

The engines 1, 2 are arranged in an axially aligned configuration. The engines may share the same housing as shown in FIG. 1. In this case, the engines are still largely of conventional design, but rather than the engine head having a closed dome, it is exposed at the hot end to the head of the adjacent engine which is also open. Alternatively, two independent engines may be mounted in close proximity to one another. These must either be connected directly to one another, or connected to a common housing, either rigidly or resiliently, such that the forces generated by one are transmitted to the other. The overall engine assembly is mounted on resilient mounts (not shown) so as to absorb small vibrations which still occur despite the balanced arrangement.

The heads 3 of the two engines are provided with a plurality of longitudinally extending fins 6 which are common to both heads. These can alternatively be annular fins or discrete pin-like fins.

As shown in FIG. 1, a single burner 7 surrounds the common heads 3 to provide heat to both. Each head 3 is, however, provided with its own annular flue gas collector 8. The burner and flue gas collector arrangements are described in greater detail below with reference to FIG. 2.

The flue gas collectors 8 lead to the heat exchanger assembly 10. This generates a heat output T for use in domestic water and space heating. The heat exchanger is divided into first 11, second 12 and third 13 chambers. In the first chamber 11, is a supplementary burner 14. This has its own gas/air supply and is operable independently of the engine burner 7. The engine burner 7 and supplementary burner 14 are controlled by a controller C. The supplementary burner 14 allows the system to satisfy a greater heat demand than is possible with the engine burner 7 alone. The supplementary burner 14 fires radially outwardly onto first heat exchanger coils 15 which provide a helical path for the circulation of a receiver liquid through the heat exchanger 10. The exhaust gases from the supplementary burner then pass around a horizontal baffle 16 and are fed to the third chamber 13 along a centrally extending duct 17. Exhaust gases from the flue gas collectors 8 are fed to a central portion of the second chamber 12, where they flow radially outwardly to the second heat exchanger coils 18 which are a continuation of the helical passage of the first coils 15. These gases pass around a lower baffle 19 into the third chamber 13 where they combine with the gases from the first chamber 11 before passing through third heat exchanger coils 20 (a continuation of the previous coils) and out through the flue gas outlet 21. At this point, the gases have cooled to a point where their temperature falls below the dew point of the mixture and condensation occurs maximising the efficiency of the heat recovery process. The condensate flows out through the condensate drain 22 via a suitable trap arrangement that is well-know in the art.

The burner assembly will now be described in greater detail with reference to FIG. 2.

The burner 7 comprises a combustion gas inlet 30 which leads tangentially to an annular recuperator channel 31, thereby causing the incoming gas to swirl around the channel. The burner 7 may be supplied with separate gas and air supplies or may be supplied with a premixture of gas and air. The channel 31 has an annular baffle 32 around which the incoming gas must flow to reach the burner. This allows it to absorb heat from the outgoing exhaust gas in the process. In the recuperator channel 31 are first 33 and second 34 mixture distribution plates which ensure an even distribution of the incoming mixture to burner mesh 35.

The burner mesh 35 has an annular configuration that may be of any known material such as knitted/woven metallic mesh, ceramic foam, ceramic plaque or any other suitable material. The mesh 35 is split into two semi-circular parts for ease of assembly and maintenance as described below.

Once the combusted gas has given up heat to the engine heads 3, it enters the flue gas collectors 8 which are shown in greater detail in FIGS. 5a and 5b. Each collector comprises an inner portion 40 and an outer manifold 41. The inner portion 40 is ceramic and has a plurality of circumferentially spaced inlets 42 which lead via expanding involute radial channels (not shown) to the plurality of outlets 43 which discharge into the manifold 41. This ensures that once the gases enter the manifold 41, they continue to flow smoothly around the circumference of the manifold and out of the tangential outlet 44 from which they are fed to the heat exchanger head.

The collector inner 40 is made of a ceramic material which consists of two semi-annular half segments split along the involute lines of the internal channels. A gasket (e.g. ceramic fibre mat or nickel-loaded graphite) 45 is provided between the halves to cushion them and to impede any flow of gases.

The manifold 41 is also assembled from a pair of semi-annular segments. The manifold has location flanges 46 on its internal surfaces. These force the segments of the inner portion 40 together on assembly so that it forms an annular flow passage 47 at the radially outermost portion of the manifold 41. As is apparent from FIG. 5a, the split between the two halves of the manifold 41 is off-set from the split of the inner portion by 90° to prevent through-flow and to minimise the risk of leakage. The two portions of the manifold 41 have overlapping ends which fit closely together with the joint being sealed by a gasket.

Although the engine assembly is designed to minimise residual vibration levels, the combined assembly will still vibrate to some extent, especially during transient operation such as start-up or grid connect/disconnect, which may create difficulties for fixed seals such as a ceramic washer. A flexible seal is therefore provided between the burner assembly and the engines 1, 2. As shown in FIG. 2, this interface is sealed by an upper annular flexible seal 50 and a lower annular flexible seal 51. In order to protect these seals from the heat of the burner and to maximise the operating efficiency of the engine an upper coolant circuit 52 is provided directly beneath the upper annular flexible seal 50 and a lower coolant circuit 53 is provided immediately above the lower flexible seal 51. This coolant circuit may either be in series with or in parallel with the coolant circuit which circulates fluid to the cool portion 4 of the engines 1, 2.

The assembly of the above described burner arrangement will now be described.

Ideally, the initial assembly of the burner around the engine pair 1, 2 is carried out horizontally before the module is mounted in place within an appliance. It is, however, possible to carry out the assembly with the engine pair 1, 2 mounted at its upper end within an appliance. Any burner removal for maintenance work will also be carried out on the vertical assembly.

The burner assembly is mounted between upper and lower burner support plates, each of which may have a two-part configuration (inner 60, 61 and outer 69, 74) to allow the outer parts 69, 74, to be installed when the engines are in situ.

Initially, upper and lower inner burner support plates 60, 61 are brazed to the engine during manufacture. Upper 62 and lower 63 insulation blocks are then fitted around the engine adjacent to the respective inner burner supports. These are again of two-part semi-annular construction. The mating faces of the two parts are sandwiched together with, for example, ceramic fibre mat or alternatively have interlocking corrugations which also serve to prevent any direct radiative path through the joint.

The inner portions 40 of the flue gas collector (shown in FIG. 5a) are then put in place. The manifolds 41 are fitted over them as described above. Semi-annular insulating support blocks 68 are then positioned on each side of the two flue gas collectors 8.

The upper outer burner support plate 69 is welded in place to the upper inner burner support plate 60. The upper annular flexible seal 50 and upper coolant channel 52 (both of which can be single annular pieces as they are large enough to fit over the engine 2) with brazed-on sealed support ring 69A are pushed up from below the engine. The upper part of the upper annular flexible seal 50 is fitted over the outermost edge of the upper outer burner support plate 69.

The burner body including the distribution plates 33, 34 and burner mesh 35, each of which is made of two semi-circular segments is then assembled around the previous components, ensuring that the burner body fits around the tangential gas collector outlet 44. The joints between the various segments are tightly fitting interlocking joints which are fitted with a gasket to prevent leakage. The coolant channel 52 is fixed with respect to the burner body using bolts 70 fixed through from the recuperator channel 31. Clamping rings 71 are fitted around the upper annular flexible seal 50 to secure the seal in position.

The lower coolant channel 53 with brazed-on seal support ring 72 is then pushed on from below and bolted in place from within the recuperator channel 31 using bolts 73. A lower outer burner support plate 74 is then welded onto the lower inner burner support plate 61.

The baffle 32 having a two-piece construction is fitted around the upper mixture distribution plate 33 and fixed in place by bolts 75. The burner inlet plate 76 again having a two-piece structure is fitted around outer locating lips 77 of the burner body taking care to fit this around the flue gas outlets 44. The joints between the two halves are fitted with a secure gasket against the opening while the flue gas outlets 44 are fitted with gas-tight seals to prevent leakage of combustible mixture. Clamping rings 78 are fitted around the burner inlet plate 76 as shown.

The lower annular flexible seal 51 is then pushed on from below around the outer edge of the outer lower burner support plate 74 and the lip of the seal support ring 72. Clamping rings 79 are fitted around the lower seal in the same way as clamping rings 71.

In the above described procedure, the cooling channels 52, 53 are one-piece annular components. It may, however, be simpler to split all of the annular components allowing the full burner assembly to be divided into semi-annular segments. The two cooling channel segments will be put into place around the heater heads, firmly sealing all joints with ceramic matting or gaskets as appropriate.

Other components such as flame probes, igniters and thermo-couples are not shown here, but would be installed, if required, in the conventional manner.

A second example of the invention is shown in FIGS. 3 and 4.

Most of the components are the same as those shown in the first examples and have been designated the same reference numerals.

The difference is that there are now two burner meshes 35a, 35b, each having its own supply of combustible gas 80. Between the two burner meshes 35a, 35b is a single flue gas collector 81 which provides only a single inlet into the second chamber 12 of heat exchanger 10 rather than the two inlets of the previous examples.

As each of the two burners has its own gas/air stream, each stream can be controlled by a controller C for the individual burner. For example, from a multi-port splitter as described in earlier WO 2004/085893. The splitter valve could also be used to supply the supplementary burner 14. This provides a system with two Stirling engines which are fully independently controllable. Alternatively, instead of a multi-port splitter valve, two consecutive two port splitter valves could be used, one to split the flow between the engines and the supplementary burner and the following one in the engine branch to control the split between the engine burners.

By contrast, control of the two engines in the first example is done via solenoid activated butterfly valves in the outlets 44.

The circulation of water through the coolant circuit 52, 53 is also controlled to control the temperatures of the cool part of the engine in the same way that the temperature at the hot end is controlled by controlling the burners referred to above.

The axial position of the burner in relation to the engine heads can be adjusted during assembly to balance the heat provided to each Stirling engine head in order to balance the operation of each engine so that they operate in true opposition, and underlying out-of-balance vibrations are minimised. The axial position can also be changed during a routine service to allow changes of balance over time to be compensated.

As the temperatures of the two engine heads can be independently controlled (as set out above) the engines can be balanced during operation. This control is desirable, in addition to controlling the axial positioning referred to above, as there may be a spread of characteristics on engines such that some difference in firing rate may be required. Alternatively, it may be necessary for the temperatures of the two engine heads to climb together, but variations in manufacturing tolerances between engines, or gravity-induced differences in operation between upper and lower engines may result in the head temperatures varying, even if heated at the same rate. The independent control can prevent this variation.

Although the designs described above use an engine pair in a vertical orientation, it is also possible to use either of the above described configurations in a horizontal configuration.

1. A domestic combined heat and power generation system comprising a pair of Stirling engines each having a head and an alternator, the two engines being mounted so that the vibrations of one substantially counteract the vibrations of the other,
at least one engine burner to heat the heads of the engines;
an auxiliary burner to provide additional heat;
a gas supply to the engine burner and auxiliary burner;
an air supply to the engine burner and auxiliary burner;
a controller to control the supply of gas and air to the engine burner and auxiliary burner;
a heat exchanger to recover heat from the exhaust gases from the engine burner and auxiliary burner and provide a heat output from the system; and
an electrical connection to the alternators to provide an electrical outlet from the system, the engines having a combined electrical power output of less than 2.5 kW.

2. A system according to claim 1, wherein the two engines share a common housing.

3. A system according to claim 1, wherein the two engines each have their own independent internal gas space.

4. A system according to claim 3, wherein the two engines are mounted to one another.

5. A system according to claim 3, wherein the two engines are mounted to a common support.

6. A system according to claim 1, wherein the engines are mounted with their heads adjacent to one another.

7. A system according to claim 6, wherein the engine burner has at least some components with a segmented configuration arranged to be assembled around the engine heads.

8. A system according to claim 7, wherein the at least some components are detachable from the engine.

9. A system according to claim 1, wherein the engines share a common burner element.

10. A system according to claim 9, wherein each engine is associated with its own exhaust gas outlet.

11. A system according to claim 10, wherein each exhaust gas outlet has its own valve.

12. A system according to claim 1, wherein each engine is associated with its own burner.

13. A system according to claim 1, wherein the engines and auxiliary burner have a maximum thermal output of less than 5 OkW.
